(19) United States
(12) Patent Application Publication
(10) Pub. No.: US 2009/0109212 A1
(43) Pub. Date: Apr. 30, 2009

(54) DISPLAY DEVICE OF ELECTRONIC APPARATUS

(75) Inventors: Hiroshi KINOSHITA, Hyogo (JP); Shinzo Okajima, Osaka (JP); Tadakazu Ogiri, Osaka (JP); Yuji Abe, Osaka (JP); Shuji Fujisawa, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 12/259,747

(22) Filed: Oct. 28, 2008

(30) Foreign Application Priority Data
Oct. 31, 2007 (JP) 2007-282813

(51) Int. Cl. G06F 17/00

(52) U.S. Cl. 345/418

(57) ABSTRACT

A display device of the present invention includes a display unit and a display control unit. The display unit is configured to be installed in an electronic apparatus. The display unit is configured to display electrically an image. The display unit is configured to maintain display of the image even if a voltage application is stopped. The display control unit is configured to control the display unit to display an image as an emblem.

### CROSS-REFERENCE TO RELATED APPLICATIONS

This application claims priority to Japanese Patent Application No. 2007-282813, filed on Oct. 31, 2007. The entire disclosure of Japanese Patent Application No. 2007-282813 is hereby incorporated herein by reference.

### BACKGROUND OF THE INVENTION

1. Field of the Invention

The present invention relates to a display device applied to an electronic apparatus such as a multifunction peripheral (MFP) and a computer.

2. Related Art

A name plate, so-called “emblem,” indicates the manufacturer's name of an apparatus, the model name of an apparatus, or the like. In the electronic apparatus (e.g., MFP), an emblem is generally attached on its outer periphery.

Thus, when a manufacturer sells an electronic apparatus, the apparatus has a brand name of its manufacturer. However, when another company sells the electronic apparatus, the apparatus may have another brand name. Also, an electronic apparatus may need various kinds of labels in accordance with its destination.

In consideration of the above-mentioned facts, some electronic apparatuses have various kinds of emblems, and the emblems are alternately attached to them. With regards to an electronic apparatus of this type, the apparatus and the various kinds of emblems are often packed together in a package when shipped. Then, unnecessary emblems will be discarded at the shipping destination.

For example, Japanese Patent Application Publication No. JP-A-2006-058689 discloses an image forming apparatus having a front cover. Here, an attachment part is mounted to the front cover, and a simple emblem and an emblem cover for covering the emblem are attached to the attachment part. According to the image forming apparatus, the emblem itself is simply formed. Therefore, production cost necessary for the emblem will be lower than that for an expensive emblem.

Also, the image forming apparatus further includes an accommodation part on the back side of the front cover. The accommodation part accommodates the emblem and the emblem cover. When the image forming apparatus is used, the emblem is attached to the attachment part mounted to the front cover. In other words, the emblem is attached on the outer side of the image forming apparatus. On the other hand, when the image forming apparatus is transported, the emblem is accommodated in the interior of the accommodation part. Therefore, the package of the image forming apparatus does not need to include a bag for protecting the emblem in addition to a bag generally used for protecting the apparatus.

According to the conventional art, the number of emblems will be increased with the increase of the model name and/or the brand name of the electronic apparatus. In addition, unnecessary emblems will be discarded. Accordingly, waste of resources still remains unresolved. Also, chance of losing any of the emblems will increase with the increase of the kinds of emblems.

In view of the above, it will be apparent to those skilled in the art from this disclosure that there exists a need for an improved electronic apparatus display device. This invention addresses this need in the art as well as other needs, which will become apparent to those skilled in the art from this disclosure.

### SUMMARY OF THE INVENTION

Accordingly, aspects of the present invention have been created to solve the above-mentioned problems occurring in the conventional practice.

According to an aspect of the present invention, a display device includes a display unit and a display control unit. The display unit is configured to be installed in an electronic apparatus. The display unit is configured to display electrically an image. The display unit is configured to maintain display of the image even if voltage application is stopped. The display control unit is configured to control the display unit to display an image as an emblem.

Objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a view of a block diagram of an image forming apparatus according to a preferred embodiment of the present invention;

FIG. 2 is a view of a diagram illustrating management data in the image forming apparatus;

FIG. 3 is a perspective view of a diagram illustrating the image forming apparatus;

FIG. 4 is a view of a flowchart illustrating a flow of controlling a display unit in the image forming apparatus;

FIG. 5 is a view of an example of a screenshot to be displayed on the display unit 11;

FIG. 6 is a view of an example of another screenshot to be displayed on the display unit 11; and

FIG. 7 is a view of an example of still another screenshot to be displayed on the display unit 11.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### 1. Image Forming Apparatus 13

An embodiment of the present invention will be hereinafter explained with reference to the attached figures. An image forming apparatus 13 will be hereinafter explained as an example of an electronic apparatus. However, the present invention is not limited to this.

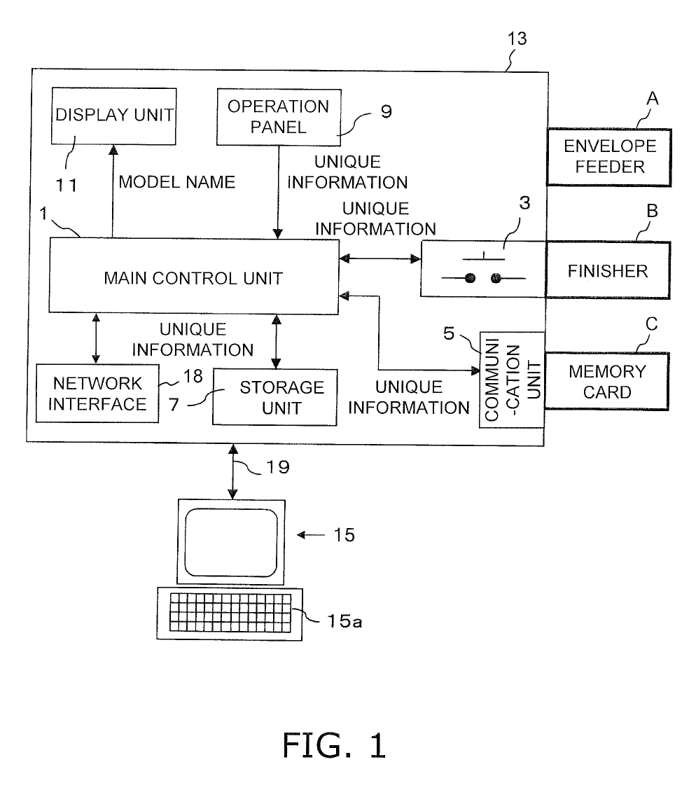

FIG. 1 is a view of a block diagram illustrating a schematic configuration of the image forming apparatus 13 and its peripheral apparatus. As illustrated in FIG. 1, the image forming apparatus 13 includes a main control unit 1, a connection detecting unit 3 a communication unit 5, a storage unit 7, a network interface 18, an operation panel 9, and a display unit 11.

Apparatuses/devices are configured to be connected to and disconnected from the image forming apparatus 13 to extend and/or to change functions of the image forming apparatus 13. For instance, the apparatuses/devices include an envelope feeder A, a finisher B, and an IC memory card C. Here, the envelope feeder A is configured to supply a plurality of envelopes. The finisher B is configured to perform post-processing (e.g., punching and stapling). The IC memory card C is configured to function as an external storage apparatus. The image forming apparatus 13 and the apparatuses A to C are electrically connected through connectors (not illustrated in the figure). Also, a computer 15 is connected to the image forming apparatus 13 as an external apparatus.

The main control unit 1 controls operations of the connection detecting unit 3, the communication unit 5, the storage unit 7, the operating panel 9, and the display unit 11. Also, the main control unit 1 is configured to rewrite after-mentioned management data, and is configured to create a model name of the image forming apparatus 13.

The connection detecting unit 3 is configured to detect whether or not the finisher B is connected to the image forming apparatus 13. For example, a mechanical on-off switch is used as the connection detecting unit 3. When the finisher B is connected to the image forming apparatus 13, the connection detecting unit 3 is configured to output a connection on-signal (i.e., detection signal) to the main control unit 1. The connection on-signal is a unique signal configured to be outputted from the connection detecting unit 3 when the finisher B is connected to the image forming apparatus 13. When receiving the signal, the main control unit 1 recognizes that the finisher B is connected to the image forming apparatus 13. In short, the connection on-signal is treated as the unique information of the finisher B.

When the memory card C is connected to image forming apparatus 13, the communication unit 5 inputs unique information of the memory card C into the main control unit 1. In addition, the communication unit 5 has a function of exchanging a variety of data between the memory card C and the main control unit 1.

The storage unit 7 preliminarily stores “management data.” The management data includes unique identification codes to indicate functions of apparatuses/devices (i.e., apparatuses A to C) to be connected to the image forming apparatus 13. Here, the unique identification codes are organized in a table.

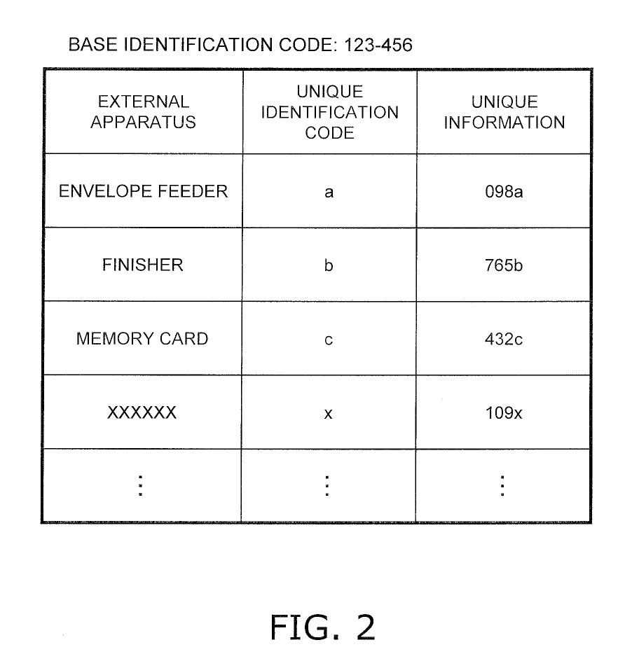

FIG. 2 illustrates an example of the management data. Referring to FIGS. 1 and 2, in addition to the above-mentioned data, the storage unit 7 is configured to store information such as image data and an operating program to be executed by the main control unit 1. For example, a hard disk drive (HDD) may be used as the storage unit 7.

As illustrated in FIG. 2, the storage unit 7 stores a base identification code “123-456” to indicate the basic configuration of the image forming apparatus 13. Furthermore, the storage unit 7 stores the unique information and the unique identification codes of external apparatuses/devices (e.g., the envelope feeder A, the finisher B, and the memory card C) connectable to the image forming apparatus 13. The unique information and the unique identification code are associated with each other. Here, “the base identification code” is made up of a string including number, alphabet, and the like, and is used to indicate the basic configuration of the image forming apparatus 13.

“The unique information” is specific to an external apparatus/device. Based on the unique information, the main control unit 1 is configured to distinguish which external apparatus/device is connected to the image forming apparatus 13. For example, the number specific to an apparatus/device is used as the unique information. The number is referred to as “ID.”

“The unique identification code” is made up of a string including number, alphabet, and the like, and is used to indicate the type of an external apparatus/device in an after-mentioned model name. As illustrated in FIG. 2, the unique recognition codes of the envelope feeder A, the finisher B, and the memory card C are respectively, “a,” “b,” and “c.” It is possible to change the content of the management data by an input through the operation panel 9 or the network interface 18 shown in FIG. 1.

The network interface 18 is configured to transmit/receive data to/from the computer 15 through a network 19. For example, information to be inputted to the network interface 18 from the computer 15 includes: a request to perform printing; the image data; a configuration of a printing condition; a configuration change of the management data; the unique information of the external apparatuses A to C; and information to be displayed as an after-mentioned emblem. The computer 15 is configured to receive the above-mentioned information from a user through a keyboard 15a, and is configured to output the information to the image forming apparatus 13. The network interface 18 is configured to output the unique information to the main control unit 1. In other words, the network interface 18 functions as an operation input unit to receive an input of the unique information of the envelope feeder A.

The computer 15 has a variety of functions in addition to the above-mentioned function. However, explanation and illustration of the detailed contents will be hereinafter omitted.

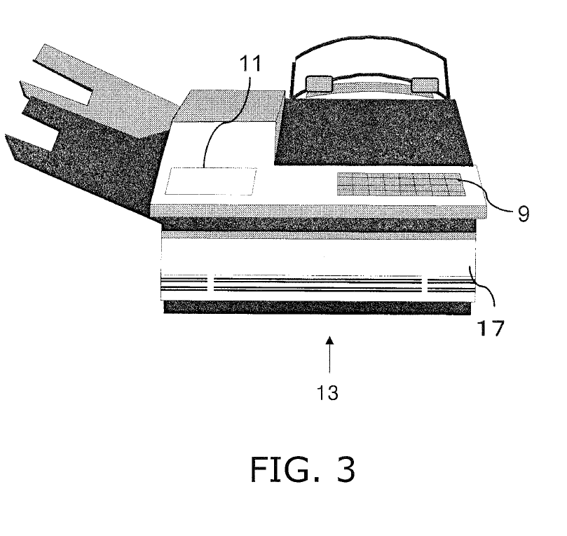

The operation panel 9 and the display unit 11 will be hereinafter explained with reference to FIGS. 1 and 3. FIG. 3 is an oblique view illustrating appearance of the image forming apparatus 13.

As illustrated in FIG. 3, the image forming apparatus 13 includes a chassis 17. The operation panel 9 and the display unit 11 are arranged on the upper part of the chassis 17. Therefore, the operation panel 9 and the display unit 11 are externally viewable for a user. The main control unit 1, the connection detecting unit 3, the communication unit 5, the storage unit 7, and the network interface 18 are arranged in the interior of the chassis 17.

The operation panel 9 includes a touch panel and a single or plurality of hard key(s). The touch panel includes a liquid-crystal display (LCD) panel and a single or plurality of touch sensors. The operation panel 9 is configured to display a variety of images through the LCD panel to a user. In addition, the operation panel 9 is configured to function as an operation input unit to receive a user's operation through the hard key(s) and the touch sensor(s). For example, the operation panel 9 is configured to receive an input such as the start and the end of the image formation, a configuration of a printing condition, a configuration change of the management data, the unique information of the external apparatuses A to C, and information to be displayed as the after-mentioned emblem.

The display unit 11 includes the so-called “electronic paper.” For example, an electrophoresis method and a method using charged particles are used as a display method of the electronic paper. However, the display method of the electronic paper is not limited to them. A power source (not illustrated in the figure) is connected to the electronic paper, and voltage is applied to the electronic paper from the power source by a driving unit (not illustrated in the figure). The electronic paper has the following property. That is, once a visual image is formed on the electronic paper by the voltage application, the electronic paper maintains the image display state even if power supply is subsequently stopped from the power source.

In addition to the above-mentioned elements, the image forming apparatus 13 includes a scanner, a printer, and the like. The scanner is configured to read optically an image from a printed manuscript and to create electronic image data. The printing unit is configured to print a monochrome image or a color image onto a sheet of paper based on the image data. These functional units are configured to operate under the control of the main control unit 1.

### 2. Main Control Unit 1

The main control unit 1 mainly includes a central processing unit (CPU), a read-only memory (ROM), a random access memory (RAM), and other storage medium. The ROM is configured to store a variety of programs such as a control program. The CPU is configured to read out a program from the ROM and execute it. The RAM is configured to function as a working area of the CPU.

The main control unit 1 has a data management function of creating and changing the management data stored in the storage unit 7 based on content of an input through the operation panel 9. Also, the main control unit 1 searches through the storage unit 7 for the unique identification codes corresponding to the external apparatuses A to C connected to the image forming apparatus 13. Then, the main control unit 1 creates a model name by the combination of the base identification code of the image forming apparatus 13 and the unique identification codes of the external apparatuses A to C. Furthermore, the main control unit 1 functions as a display control unit to write the model name into the display unit 11 and controlling the display unit 11 to display visually the model name.

### 3. Display Control

The main control unit 1 is configured to control the display unit 11 to display an emblem.

“The emblem” is used to display information regarding the image forming apparatus 13 and a single or plurality of external apparatus(es)/device(s) connected to the image forming apparatus 13. Specifically, the information includes the model name, the manufacturer's name, the distributor's name, and the connected apparatus's name, and the like. The emblem may include any of the above-mentioned information. Also, the emblem may include not only a character but also a sign, an image (e.g., graphic), and the like.

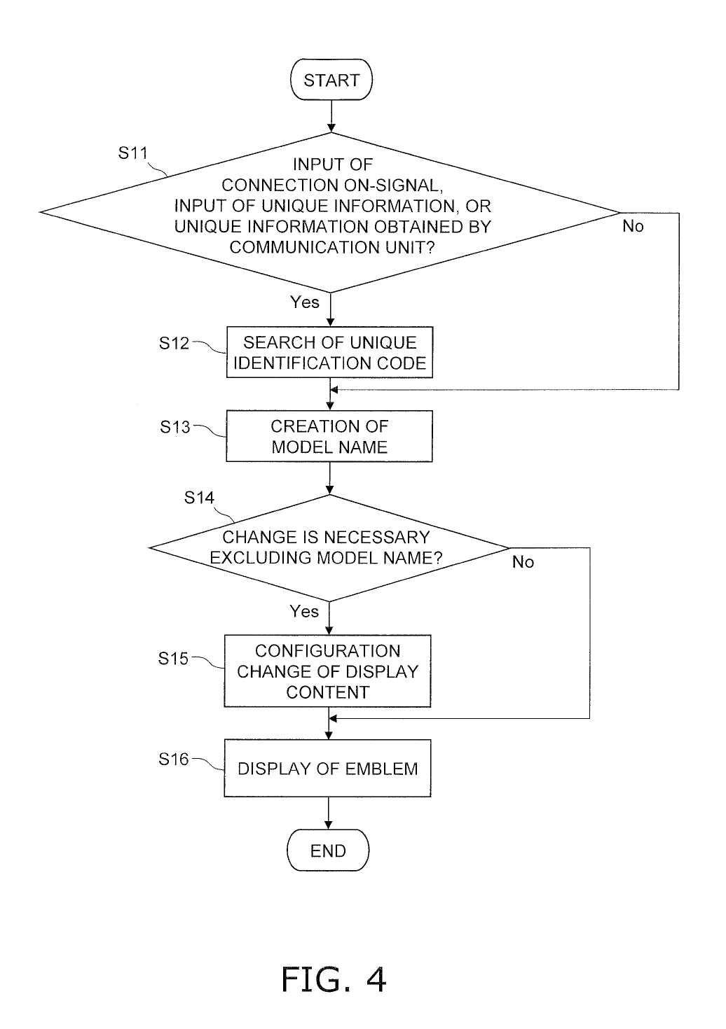

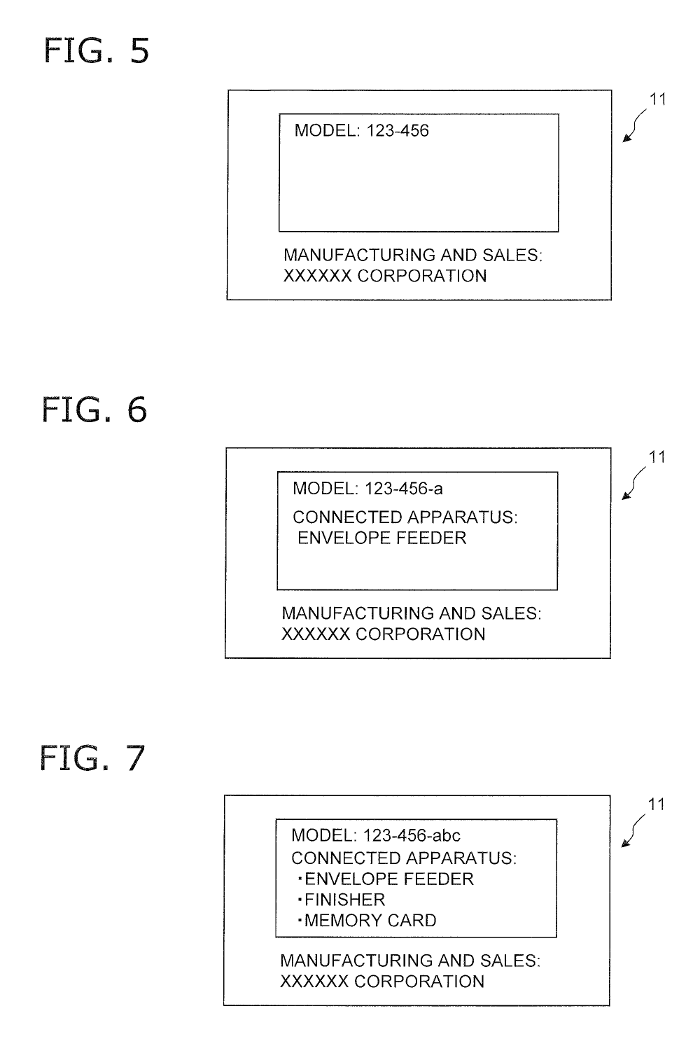

Control of the display unit 11 performed by the main control unit 1 will be hereinafter explained with reference to FIGS. 4 to 7. FIG. 4 is a flowchart illustrating a flow of the display control. FIGS. 5 to 7 are screenshots of an emblem to be displayed on the display unit 11.

As illustrated in FIGS. 1 and 4, when a connection on-signal is transmitted from the connection detecting unit 3 to the main control unit 1, the main control unit 1 judges that the finisher B is connected to the image forming apparatus 13. Accordingly, the main control unit 1 searches through the management data stored in the storage unit 7 for the unique identification code corresponding to the finisher B (from Yes in Step S11 to Step S12).

Also, when the envelope feeder A is connected to the image forming apparatus 13 and then the operation panel 9 or the network interface 18 receives the unique information of the envelope feeder A, the main control unit 11 searches through the management data for the unique identification code corresponding to the unique information (From Yes in Step S11 to Step S12).

Also, when the memory card C is connected to the image forming apparatus 13 and the communication unit 5 receives the unique information from the memory card C, the main control unit 1 searches through the management data for the unique identification code corresponding to the unique information (from Yes in Step S11 to Step S12).

The main control unit 1 creates a model name by the combination of the obtained unique identification code and the base identification code of the image forming apparatus 13 (Step S13). Here, “the model name” means a code to indicate totally the image forming apparatus 13 (i.e., the basic element) and a single or plurality of external apparatus(es)/device(s) connected to the image forming apparatus 13 to extend or to change the functions of the image forming apparatus 13.

For example, if the envelope feeder A is exclusively connected to the image forming apparatus 13 as the external apparatus, the main control unit 1 creates “123-456-a” as the model name by the combination of the base identification code (i.e., “123-456”) of the image forming apparatus 13 and the unique identification code (i.e., “a”) of the connected envelope feeder A. Similarly, if the finisher B or the memory card C is exclusively connected to the image forming apparatus 13, the main control unit 1 respectively creates “123-456-b” or “123-456-c” as the model name by the combination of the base identification code (i.e., “123-456”) of the image forming apparatus 13 and the unique identification code of the connected finisher B (i.e., “b”) or memory card C (i.e., “c”).

Also, when a plurality of external apparatuses/devices is connected to the image forming apparatus 13, the main control unit 1 adds a plurality of unique identification codes into the model name. For example, if the envelope feeder A and the finisher B are connected to the image forming apparatus 13 but the memory card C is not connected to the image forming apparatus 13, the main control unit 1 creates “123-456-ab” as the model name. Also, if the finisher B and the memory card C are connected to the image forming apparatus 13 but the envelope feeder A is not connected to the image forming apparatus 13, the main control unit 1 creates “123-456-bc” as the model name. Furthermore, when all of the three external apparatuses are connected to the image forming apparatus 13, the main control unit 1 creates “123-456-abc” as the model name.

Here, the main control unit 1 may not necessarily add all the unique identification codes of the connected external apparatuses/devices in the model name. For example, even if all the external apparatuses A to C are connected to the image forming apparatus 13, the main control unit 1 may set the base identification code as the model name. Also, the main control unit 1 may combine two of the unique identification codes “a,” “b,” and “c,” and may add the combined codes in the model name. Furthermore, when none of the external apparatuses/devices is connected to the image forming apparatus 13, the base identification code may be set as the model name.

Then, when the network interface 18 or the operation panel 9 receives an instruction to change the display content excluding the model name (Yes in Step S14), the main control unit 1 accordingly changes the configuration of the display content on the display unit 11 (Step S15). For example, this is performed when an emblem needs to be changed in accordance with a destination, or when not a manufacturer but another company (i.e., distributor) sells the image forming apparatus 13 and an emblem of the distributor is accordingly required in addition to an emblem of the manufacturer.

The main control unit 1 controls the display unit 11 to display an emblem including thus created model name and other information (Step S16).

With reference to FIGS. 5 to 7, display of an emblem will be hereinafter specifically exemplified. In examples illustrated in FIGS. 5 to 7, the main control unit 1 controls the display unit 11 to display the model name, the name of a company manufacturing and selling the image forming apparatus 13, and the name of an external apparatus/device connected to the image forming apparatus 13.

FIG. 5 illustrates an emblem to be displayed when no external apparatus/device is connected to the image forming apparatus 13. Here, the model name is set to be the base identification code “123-456.”

FIG. 6 illustrates an emblem to be displayed when the envelope feeder A is connected to the image forming apparatus 13. As explained above, the model name “123-456-a” is created by the combination of the base identification code of the image forming apparatus 13 (i.e., “123-456”) and the unique identification code of the envelope feeder A (i.e., “a”). Also, the display unit 11 displays “ENVELOPE FEEDER” as the name of the connected external apparatus.

FIG. 7 illustrates an emblem to be displayed when all of the envelope feeder A, the finisher B, and the memory card C are connected to the image forming apparatus 13. As explained above, the model name “123-456-abc” is created by the combination of the base identification code of the image forming apparatus 13 (i.e., “123-456”) and the unique identification codes of the external apparatuses A to C (i.e., “a,” “b,” and “c”). Also, the display unit 11 displays “ENVELOPE FEEDER,” “FINISHER,” and “MEMORY CARD” as the names of the three connected apparatuses.

Even if the image forming apparatus 13 is powered off, the display unit 11 maintains the display state. Therefore, even in the power-off condition, a user is capable of visually recognizing information such as the model name.

Also, if a condition is changed (e.g., connection/removal of an external apparatus/device), the model name will be accordingly changed. Therefore, the image forming apparatus 13 does not need a plurality of emblems. Also, a user is capable of grasping the above-mentioned conditional change by looking at the model name. Therefore, a user easily understands functions of the image forming apparatus. Furthermore, a user easily performs maintenance of the image forming apparatus 13 because of the easy-understanding of the device's functions. Thus, the image forming apparatus 13 reduces waste of resources, and is highly convenient for a user and a technical service engineer.

In general, it is difficult to prepare preliminarily an emblem in consideration of all the combinations of external apparatuses/devices. However, even if a newly-developed external apparatus/device is connected to the image forming apparatus 13, the image forming apparatus 13 is configured to change the model name as long as the unique identification code of the newly-developed external apparatus/device is obtained.

Also, when the finisher B is connected to the image forming apparatus 13, the main control unit 1 searches the unique identification code of the finisher B based on the connection on-signal transmitted by the connection detecting unit 3, then creates a model name, and controls the display unit 11 to display the model name. Furthermore, when the memory card C is connected to the image forming apparatus 13, the main control unit 1 obtains the unique information of the memory card C through the communication unit 5. Then, the main control unit 1 searches through the storage unit 7 for the unique identification code based on the unique information, then creates a model name, and controls the display unit 11 to display the model name. In other words, all a user needs to do is to connect the finisher B or the memory card C to the image forming apparatus 13. Display of the model name is automatically changed by the image forming apparatus 13. Therefore, user's workload required to exchange emblems will be remarkably reduced.

The unique information may be automatically obtained, or may be manually inputted by a user. As described above, the image forming apparatus 13 includes the operation input unit to receive an input of the unique information of the envelope feeder A. Therefore, the image forming apparatus 13 may search through the storage unit 7 for the unique identification code based on the inputted unique information, then create a model name, and control the display unit 11 to display the model name.

As described above, the display unit 11 and the main control unit 1 function as a display device while they are installed in the image forming apparatus 13 (i.e., electronic apparatus).

### Other Example Embodiments

(a) The unique identification code may be preliminarily stored, or may be obtained from an external apparatus/device when the external apparatus/device is connected to the image forming apparatus 13. In other words, the unique information explained in the above section of the image forming apparatus 13 may be the unique identification code itself. In short, the unique identification code may be obtained through the communication unit 5, the network interface 18, or the operation panel 9.

(b) As described above, the content of the emblem is not limited to a particular content. For example, the model name is not limited to the combination of the base identification code of the image forming apparatus 13 and the unique identification codes of the external apparatuses A to C. Only the unique identification codes of the connected external apparatuses A to C may be set as the model name. As described above, however, if the model name is created by the combination of the base identification code and the unique identification code, a user is capable of easily grasping the total functions of the image forming apparatus 13 and the external apparatuses/device from the model name.

(c) The display device of the present invention is not limited to be applied to the image forming apparatus 13. The display unit may be applied to a MFP, a facsimile machine, a computer, and other electronic apparatuses. Also, an external apparatus/devices to be connected to the electronic apparatus is not limited to a finisher or an IC memory card. The external apparatus/device may be a variety of apparatuses/devices to be installed in or externally connected to the electronic apparatus. Also, the connected apparatuses/devices are not particularly limited to an extension apparatus/device to extend the basic configuration of the electronic apparatus or a change apparatus/device to change the basic configuration of the electronic apparatus.

(d) In the above-mentioned first embodiment, the display device forms a part of the electronic apparatus (i.e., the image forming apparatus 13). However, the display device and the electronic apparatus may be separately provided.

### General Interpretation

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A display device, comprising:
a display unit being installed in an electronic apparatus, the display unit being configured to display electrically an image, the display unit being configured to continue to display the image when a voltage application has stopped; and
a display control unit being configured to control the display unit to display the image as an emblem.

2. The display device according to claim 1, wherein
the display control unit is configured to control the display unit to display at least one of a manufacturer's name of the electronic apparatus, a distributor's name of the electronic apparatus, a model name of the electronic apparatus, and a name of an external apparatus connected to the electronic apparatus.

3. The display device according to claim 1, wherein
the electronic apparatus includes a base identification code, and
wherein the display control unit is configured to control the display unit to display the base identification code.

4. The display device according to claim 1, wherein
the electronic apparatus is configured to be connected to another apparatus including a unique identification code, and
wherein the display control unit is configured to control the display unit to display the unique identification code of the another apparatus connected to the electronic apparatus.

5. The display device according to claim 4, wherein
the electronic apparatus includes a base identification code, and
wherein the display control unit is configured to control the display unit to display the base identification code and the unique identification code.

6. The display device according to claim 5, wherein
the display control unit is configured to create a model name by combining the base identification code and the unique identification code and is configured to control the display unit to display the mode name.

7. The display device according to claim 4, further comprising
a storage unit configured to store a unique identification code of the another apparatus and unique information of the another apparatus while the unique identification code and the unique information are associated to each other, and
wherein the display control unit is configured to search through the storage unit for the unique identification code of the another apparatus connected to the electronic apparatus based on the unique information and is configured to control the display unit to display the searched unique identification code.

8. The display device according to claim 7, further comprising
a connection detecting unit, the connection detecting unit configured to detect connection of the electronic apparatus to the another apparatus, the connection detecting unit configured to transmit unique information of the another apparatus connected to the electronic apparatus to the display control unit, wherein
the display control unit is configured to control the display unit to display the unique identification code corresponding to the unique information transmitted from the connection detecting unit.

9. The display device according to claim 7, further comprising
a communication unit, the communication unit configured to obtain the unique information from the another apparatus connected to the electronic apparatus, the communication unit configured to transmit the obtained unique information to the display control unit, wherein
the display control unit is configured to control the display unit to display the unique identification code corresponding to the unique information transmitted from the communication unit.

10. The display device according to claim 7, further comprising
an operation input unit, the operation input unit configured to receive an input of the unique information from a user, the operation input unit configured to transmit the received input to the display control unit, wherein
the display control unit is configured to control the display unit to display the unique identification code corresponding to the unique information transmitted from the operation input unit.

11. The display device according to claim 1, wherein the display unit is an electronic paper.
